(19) United States
(12) Patent Application Publication
(10) Pub. No.: US 2019/0154012 A1
(43) Pub. Date: May 23, 2019

(54) METHOD AND SYSTEM FOR DYNAMIC BALANCING OF A CORE IN AN ENERGY RECOVERY DEVICE

(71) Applicant: Exergyn Limited, Glasnevin, Dublin (IE)

(72) Inventor: Kevin O'Toole, Glasnevin, Dublin (IE)

(21) Appl. No.: 16/313,199

(22) PCT Filed: Jun. 28, 2017
(86) PCT No.: PCT/EP2017/066065

§ 371 Date: Dec. 26, 2018

(30) Foreign Application Priority Data
Jun. 28, 2016 (IE) 1611170.0

(51) Int. Cl. F03G 7/06

(52) U.S. Cl. CPC F03G 7/065

(57) ABSTRACT

The invention provides an energy recovery system comprising a first Shape-Memory Alloy (SMA) or Negative Thermal Expansion (NTE) core and a first hydraulic chamber in communication with one end of the first core and adapted to convert movement of the core into energy; and a second Shape-Memory Alloy (SMA) or Negative Thermal Expansion (NTE) core and a second hydraulic chamber in communication with one end of the second core and adapted to convert movement of the core into energy. A storage energy device is configured and adapted to absorb the difference in the energy output from the first and second hydraulic chambers during operation.

### FIELD

The present application relates to the field of energy recovery and in particular to the use of shape memory alloys (SMA) or Negative Thermal Expansion materials (NTE) for same.

### BACKGROUND

Low grade heat, which is typically considered less than 100 degrees, represents a significant waste energy stream in industrial processes, power generation and transport applications. Recovery and re-use of such waste streams is desirable. An example of a technology which has been proposed for this purpose is a Thermoelectric Generator (TEG). Unfortunately, TEGs are relatively expensive. Another largely experimental approach that has been proposed to recover such energy is the use of Shape-Memory Alloys.

A Shape-Memory Alloy (SMA) is an alloy that “remembers” its original, cold-forged shape which once deformed returns to its pre-deformed shape upon heating. This material is a lightweight, solid-state alternative to conventional actuators such as hydraulic, pneumatic, and motor-based systems.

The three main types of shape-memory alloys are the copper-zinc-aluminium-nickel, copper-aluminium-nickel, and nickel-titanium (NiTi) alloys but SMAs can also be created, for example, by alloying zinc, copper, gold and iron.

The memory of such materials has been employed or proposed since the early 1970s for use in heat recovery processes and in particular by constructing SMA engines which recover energy from heat as motion. Recent publications relating to energy recovery devices include PCT Patent Publication number WO2013/087490, assigned to the assignee of the present invention. It is desirable to translate the contraction of the SMA or NTE material into a mechanical force in an efficient manner. It is not a trivial task and generally is complicated and involves significant energy losses.

It is therefore an object to provide an improved system and method in an energy recovery device.

### SUMMARY

According to the invention there is provided, as set out in the appended claims, an energy recovery system comprising:
a first Shape-Memory Alloy (SMAs) or Negative Thermal Expansion (NTE) core and a first hydraulic chamber in communication with one end of the first core and adapted to convert movement of the core into energy; and
a second Shape-Memory Alloy (SMA) or Negative Thermal Expansion (NTE) core and a second hydraulic chamber in communication with one end of the second core and adapted to convert movement of the core into energy; and
wherein a storage energy device is configured and adapted to absorb the difference in the energy output from the first and second hydraulic chambers during operation.

The invention solves the problem of differences in SMA core output (displacement, force or pressure) as a result of inconsistent SMA core operation. The inconsistent output can be a result of different fluid input temperatures, or inconsistencies in core assembly, or differences in wire chemical constituents.

In one embodiment the storage energy device comprises an accumulator.

In one embodiment the storage energy device comprises a mechanical device.

In one embodiment the storage energy device comprises a biasing device.

In one embodiment there is provided a transmission line connecting the first and second hydraulic chambers.

In one embodiment the first core and second core are in fluid communication with each other housed in an immersive chamber and comprising a single inlet at the first core to receive fluid and a single outlet at the second core to discharge the received fluid.

In one embodiment the inlet of the first core and outlet of the second core is changed periodically to receive said fluid such that flow of the fluid is reversed.

In one embodiment the first and second cores are housed in a first and second immersive chamber and connected by a channel to define a single core pair.

In a further embodiment there is provided method of energy recovery comprising the steps of:
positioning a first Shape-Memory Alloy (SMAs) or Negative Thermal Expansion (NTE) core and a first hydraulic chamber in communication with one end of the first core and converting movement of the core into energy; and
positioning a second Shape-Memory Alloy (SMA) or Negative Thermal Expansion (NTE) core and a second hydraulic chamber in communication with one end of the second core and converting movement of the second core into energy; and
absorbing the difference in the energy output from the first and second hydraulic chambers during operation by using a storage energy device.

### BRIEF DESCRIPTION OF THE DRAWINGS

The invention will be more clearly understood from the following description of an embodiment thereof, given by way of example only, with reference to the accompanying drawings, in which:

FIG. 1 illustrates a known energy recovery system;

FIG. 2 illustrates a first embodiment of the invention showing a first core and a second core in communication with a first and second hydraulic chambers;

FIG. 3 illustrates the displacement/force/pressure vs time graph illustrated for the first and second cores; and

FIG. 4 illustrates a second embodiment of the invention showing a first core and a second core in fluid communication with each other and in communication with a first and second hydraulic chambers.

### DETAILED DESCRIPTION OF THE DRAWINGS

The invention relates to a heat recovery system under development which can use either Shape-Memory Alloys (SMAs) or Negative Thermal Expansion materials (NTE) to generate power from low grade heat.

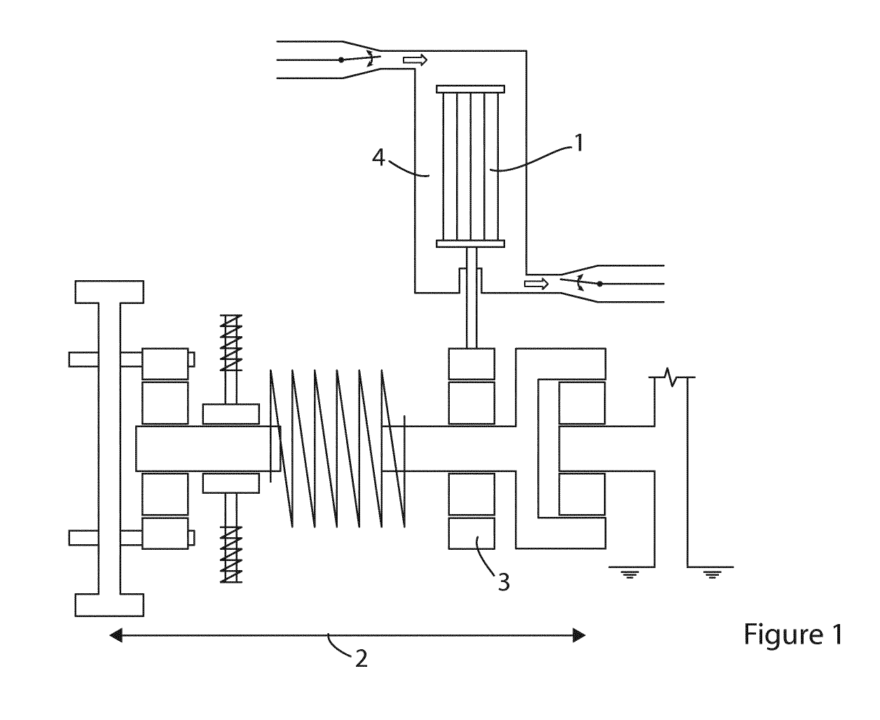

An exemplary known embodiment of an energy recovery device will now be described with reference to FIG. 1 which provides an energy recovery device employing a SMA engine indicated by reference numeral 1. The SMA engine 1 comprises an SMA actuation core. The SMA actuation core is comprised of SMA material clamped or otherwise secured at a first point which is fixed. At the opposing end, the SMA material is clamped or otherwise secured to a drive mechanism 2. Thus whilst the first point is anchored the second point is free to move albeit pulling the drive mechanism 3. An immersion chamber 4 is adapted for housing the SMA engine and is also adapted to be sequentially filled with fluid to allow heating and/or cooling of the SMA engine. Accordingly, as heat is applied to the SMA core it is free to contract. Suitably, the SMA core comprises a plurality of parallel wires, ribbons or sheets of SMA material. It will be appreciated that in the context of the present invention the term ‘wire’ is used and should be given a broad interpretation to mean any suitable length of SMA or NTE material that can act as a core.

Typically, a deflection in and around 4% is common for such a core. Accordingly, when a 1 m length of SMA material is employed, one might expect a linear movement of approximately 4 cm to be available. It will be appreciated that the force that is provided depends on the mass of wire used. Such an energy recovery device is described in PCT Patent Publication number WO2013/087490, assigned to the assignee of the present invention, and is incorporated fully herein by reference.

For such an application, the contraction of such material on exposure to a heat source is captured and converted to usable mechanical work. A useful material for the working element of such an engine has been proven to be Nickel-Titanium alloy (NiTi). This alloy is a well-known Shape-Memory Alloy and has numerous uses across different industries. It will be appreciated that any suitable SMA or NTE material can be used in the context of the present invention.

Force is generated through the contraction and expansion of this alloy (presented as a plurality of wires) within the working core, via a piston and transmission mechanism. Accordingly, depending on the requirements of a particular configuration and the mass of SMA material needed, a plurality of SMA wires may be employed together, spaced substantially parallel to each other, to form a single core. The system and invention is directed to solving problems associated with such engine cores comprising a plurality of elongated wire elements arranged in a bundle arrangement to define a core.

When the working core is exposed to the hot stream of fluid, the alloy, or plurality of wires, reacts by contracting forcefully in the longitudinal direction. When exposed to the cold stream of fluid, it returns to its original length. The time of this reaction is of most importance when considering power production. A problem arises if two cores, connected via a transmission system, are exposed to different temperatures, for example if one core is exposed to 90° C. whilst an adjacent core is exposed to 85° C. In such a circumstance, the alloy that is exposed to the higher temperature will react faster than the other alloy core. Such a disparity in reaction time can have negative implications for the operation of the engine in a reliable fashion, as the dynamic performance of cores will be unmatched which can lead to problems such as irregular pulsing in the motor, dynamic unbalancing and premature fatigue for example.

The present invention provides a system and method to balance any differences in core activation times, and hence power production by the cores, that can affect the consistency of the system motor rotation. The method and system of the invention described herein can be effective when the cores are operated in an individual parallel setup, where a fluid stream fills a number of cores in parallel, or in a cascade setup, where the fluid stream fills a number of cores in series.

### Parallel Core Embodiment

In an individual parallel setup, a difference in power production (as a result of a is difference in the rate of change of either displacement of the SMA, the force generated by the SMA, or the pressure produced in the core) can be as a result of a difference in temperature of the hot fluid as it enters the core or chamber housing the core. Higher fluid input temperatures result in the SMA reactions occurring faster than they would if the fluid input temperature was lower. Higher temperatures result in the temperature of the SMA element rising faster, and as a result, completes the phase change (or contraction) in a faster time. In a cascade setup, lower fluid input temperatures in any subsequent core in a serial chain of cores is always the case as a result of heat being extracted from the fluid by initial cores in the chain.

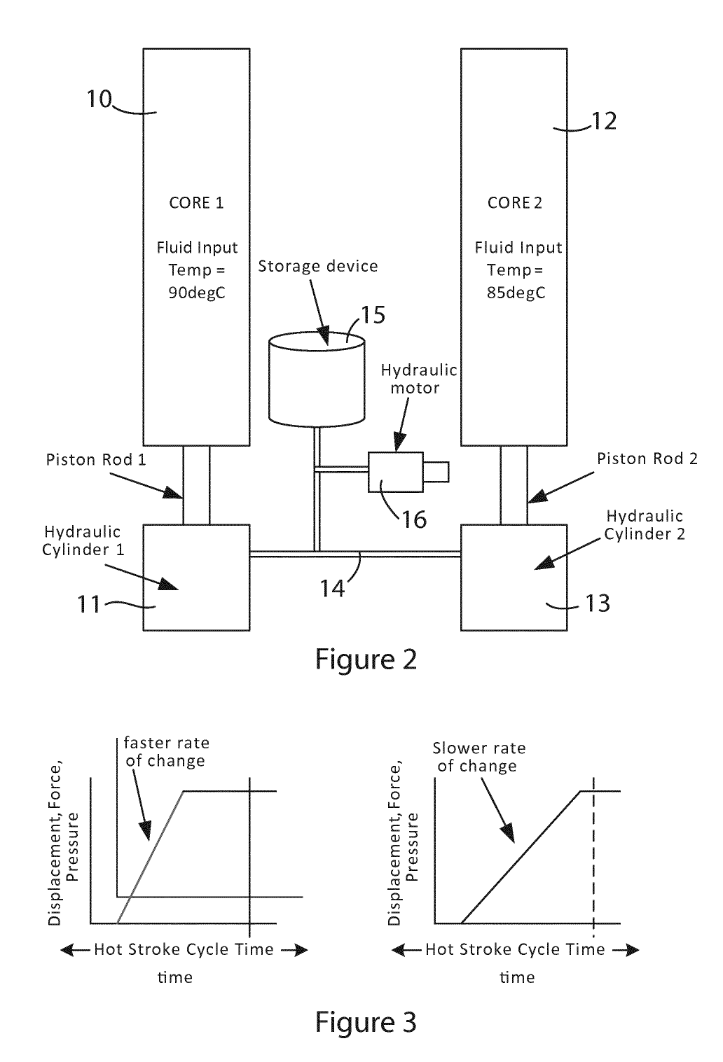

FIG. 2 illustrates an energy recovery device comprising a first Shape-Memory Alloy (SMA) or Negative Thermal Expansion (NTE) core 10 and a first hydraulic chamber 11 in communication with one end of the first core 10 and is adapted to convert movement of the core into energy. A second Shape-Memory Alloy (SMA) or Negative Thermal Expansion (NTE) core 12 and a second hydraulic chamber 13 in communication with one end of the second core is adapted to convert movement of the core into energy. A transmission line 14 is provided connecting the first and second hydraulic chambers 11, 13. In the example outlined in FIG. 2, Core 1 has an input temperature of 90 deg C., while Core 2 has an input temperature of 85 deg C. This difference in temperature can result in inefficient operation of the power stroke in the first and/or hydraulic chamber.

FIG. 3 illustrates the displacement/force/pressure vs time graph illustrated below each core in the diagram, and illustrates the difference in the rate of change of the SMA when subjected to these input fluid temperatures. As a result, the pulse of fluid leaving each hydraulic chamber upon SMA activation is different.

FIG. 2 further shows a storage energy device 15 configured and adapted to absorb the difference in the energy output from the first and second hydraulic chambers 11, 13 during operation. A hydraulic motor 16 is also provided. The storage device 15 is placed on the transmission line 14 and is capable of absorbing the differences in the output from the hydraulic chambers 11, 13 during operation. The storage device 15 can be an accumulator, spring or similar. In order to extract the maximum quantity of energy during the power stroke, the timing of core operation must always be set to a time that encompasses the time taken for a core to activate with the lowest allowable fluid input temperature.

### Cascade Core Embodiment

In a second embodiment it will be appreciated, as outlined above, when the energy recovery system is exposed to the hot stream of fluid, the core reacts by contracting forcefully in the longitudinal direction. When exposed to the cold stream of fluid, it returns to its original length. The time of this reaction is of importance when considering power production.

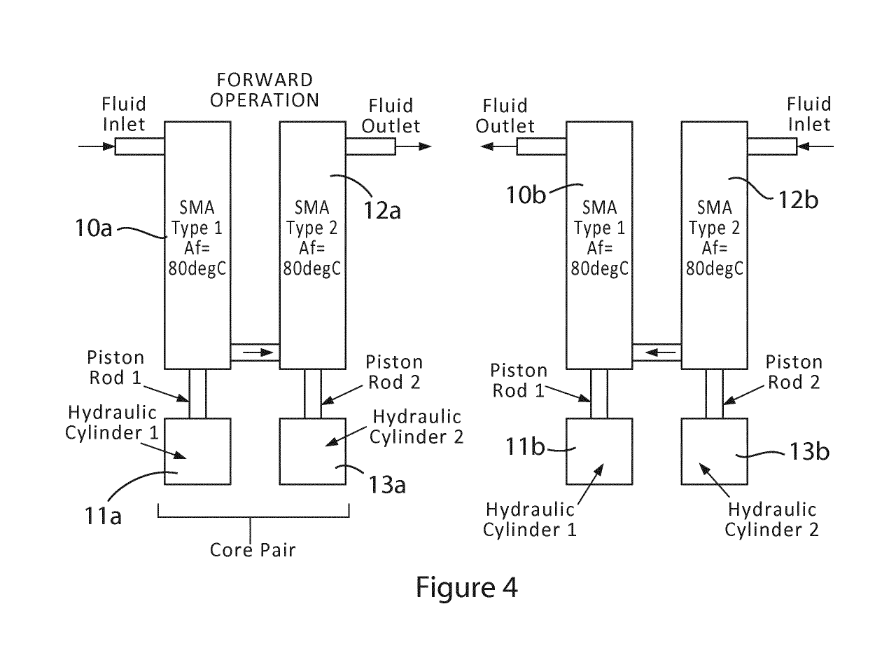

FIG. 4 illustrates a second embodiment of the invention showing a first core and a second core 10a, 12a in fluid communication with each other and in communication with a first and second hydraulic chambers 11a, 13a, referred to as a cascade embodiment. The first and second cores are housed in an immersive chamber connected by a channel.

In the cascade embodiment of FIG. 4, a fluid is inputted into one core, its output is connected to another core in series, and the fluid is passed through the cores in series; the first core in the cascade is always subjected to a higher fluid temperature, as each cascade extracts heat out of the fluid as it passes through. This causes the SMA core to respond in a faster manner as the SMA strands heat in a faster time relative to the next core in the cascade chain, which results in a higher rate of displacement, force and pressure being applied to the initial core housing and associated transmission elements.

This can lead to an imbalance in stress applied to one core over subsequent cores in the cascade. To tackle this problem, a method of balancing core fatigue presented between the first and second cores or ‘core pair’ 10a, 12a. This involves utilizing the same SMA variant in each core (a variant with an Austenite finish (Af) temperature of 80 deg C. in the given example, but any variant is acceptable). The inlet and outlet of the core pair is changed periodically, thus allowing each core to experience the higher inlet temperature and faster associated SMA reaction, and thus balancing the stress experienced by the transmission elements attached to each core unit.

To expand the system of the invention further, core pairs can be coupled together, whereby the first core pair feeds 10a, 12a a second core pair 10b, 12b with an associated hydraulic chamber 11b and 13b as shown in FIG. 4. This multiplication of core pairs can continue until the fluid temperature entering any core in the chain falls below Af. At this point, the temperature of the fluid is not high enough to fully activate the SMA in the core.

The solution presented solves the problem of an imbalance in stress applied to cores during cascade operations. When cores are subjected to a stress profile that is uneven across the system, it can result in stress failures occurring over time.

In the specification the terms “comprise, comprises, comprised and comprising” or any variation thereof and the terms include, includes, included and including” or any variation thereof are considered to be totally interchangeable and they should all be afforded the widest possible interpretation and vice versa.

The invention is not limited to the embodiments hereinbefore described but may be varied in both construction and detail.

1. An energy recovery system comprising:
a first Shape-Memory Alloy (SMAs) or Negative Thermal Expansion (NTE) core and a first hydraulic chamber in communication with one end of the first core and adapted to convert movement of the core into energy; and
a second Shape-Memory Alloy (SMA) or Negative Thermal Expansion (NTE) core and a second hydraulic chamber in communication with one end of the second core and adapted to convert movement of the second core into energy; and
wherein a storage energy device is configured and adapted to absorb the difference in the energy output from the first and second hydraulic chambers during operation.

2. The energy recovery system as claimed in claim 1 wherein the storage energy device comprises an accumulator.

3. The energy recovery system as claimed in any preceding claim wherein the storage energy device comprises a mechanical device.

4. The energy recovery system as claimed in any preceding claim wherein the storage energy device comprises a biasing device.

5. The energy recovery system as claimed in any preceding claim comprising a transmission line configured to connect the first and second hydraulic chambers.

6. The energy recovery system as claimed in any preceding claim wherein the first core and second core are in fluid communication with each other housed in an immersive chamber and comprising a single inlet at the first core to receive fluid and a single outlet at the second core to discharge the received fluid.

7. The energy recovery system as claimed in claim 6 wherein the function of the inlet of the first core and the outlet of the second core is configured to be changed to receive said fluid such that flow of the fluid is reversed.

8. The energy recovery system as claimed in any of claims 6 or 7 wherein the first and second cores are housed in a first and second immersive chamber and connected by a channel to define a single core pair.

9. A method of energy recovery comprising the steps of:
positioning a first Shape-Memory Alloy (SMAs) or Negative Thermal Expansion (NTE) core and a first hydraulic chamber in communication with one end of the first core and converting movement of the core into energy; and
positioning a second Shape-Memory Alloy (SMA) or Negative Thermal Expansion (NTE) core and a second hydraulic chamber in communication with one end of the second core and converting movement of the second core into energy; and
absorbing the difference in the energy output from the first and second hydraulic chambers during operation by using a storage energy device.
